(19) United States
(12) Patent Application Publication
(10) Pub. No.: US 2026/0272225 A1
(43) Pub. Date: Sep. 17, 2026

(54) Portable Food Storage Apparatus Utilizing Available On-Site Battery Power for Heating Food

(71) Applicant: Joel DeCarli, Archbald, PA (US)

(72) Inventor: Joel DeCarli, Archbald, PA (US)

(21) Appl. No.: 19/557,325

(22) Filed: Mar. 5, 2026

Related U.S. Application Data
(60) Provisional application No. 63/770,421, filed on Mar. 12, 2025.

(51) Int. Cl. A47J 41/00; A45C 11/20

(52) U.S. Cl. CPC A47J 41/005; A45C 11/20

(57) ABSTRACT

A food storage apparatus is proposed that is portable and uses an available, on-site external power supply (e.g., rechargeable high-voltage battery, such as that used with common power tools) to energize a heating element disposed within the body of the food storage apparatus. The apparatus is configured to include a socket for accepting a conventional battery source. A container for the food may be removably positioned within a recessed compartment of the apparatus so as to be centered over the heating element. An external power switch, connecting the socket to the heating element, is controlled by an individual to initiate (or stop) the heating process. An indicator device (e.g., LED) may be included and used by the individual to determine when the heating is completed.

### CROSS-REFERENCE TO RELATED APPLICATIONS

This application claims priority from U.S. Provisional Application Ser. No. 63/770,421, filed Mar. 12, 2025 and herein incorporated by reference.

### TECHNICAL FIELD

The present invention relates to a lunch box type of food storage apparatus and, more particularly, to a food storage apparatus that is configured to reheat a container of food by using an on-site rechargeable high-voltage battery such as an available power tool battery which typically operates at 10V or higher.

### BACKGROUND OF THE INVENTION

A significant number of working people take a lunch (or snack or dinner) along with them to work, as a timesaver during a break time or a way to cut down on spending extra money for meals. In office or commercial facilities that have a breakroom, an employee typically has access to a microwave (or some other type of heating appliance) to warm up the food brought from home to an acceptable temperature.

However, there are millions of people that work on a job site that does not have typical “lunch room” facilities such as a refrigerator or a microwave, or even access to an available power source. Without any capability to reheat (or cook) a complete meal, these workers are typically limited in available lunch options to a sandwich, or purchasing expensive items from a local food truck or restaurant. Others may work at a residential or commercial construction site (for example) where they have no access to appliances such as a microwave, even if available for residents or employees.

Thus, a need remains in the art for a portable, rugged food storage apparatus that may be taken along to a job site and have the capability to utilize an on-site high-voltage battery source to prepare the food stored therein.

### SUMMARY OF THE INVENTION

The need remaining in the prior art is addressed by the present invention, which relates to a food storage apparatus and, more particularly, to a portable food storage apparatus that is intended to be taken on location with the user and configured to work with an available on-site power source to heat the food stored therein. In particular, the “on-site power source” is intended to be defined as a “rechargeable high-voltage battery” such as a conventional power tool battery.

In accordance with the principles of the present invention, an example portable food storage apparatus comprises a base member having sidewalls and a recessed portion defined in a central area, a heating element disposed upon the recessed portion of the base member, a socket configuration for receiving electrical power from a co-located, portable external power source, a power switch for connecting the socket configuration to the heating element as controlled by a user, and a food container disposed over the heating element, where in response to the activation by a user, thermal energy produced by the heating element is used to raise the temperature of food stored therein.

In several embodiments, the inventive food storage apparatus may include a simple on/off control switch and an associated status indicator (e.g., LEDs) to alert the user to the food reaching the desired temperature. In preferred embodiments, a temperature sensor may be used in conjunction with the heating element to monitor the food heating process and provide indications of the status of the process.

The inventive portable food storage apparatus preferably includes a cover to ensure that the food container itself will not become separated from the surrounding components, while also ensuring that any type of debris or other material external to the food storage apparatus will not come into contact with the included heating element. The cover may be configured to include latching mechanisms that mate with like components on standard tool boxes (or the like) such that the inventive apparatus may be stacked with job site equipment/tools for easier transport and efficient storage (among other benefits).

An exemplary embodiment may take the form of a portable food storage apparatus comprising a base member, a heating element, a socket configuration, a power switch, and a removeable food container. The base member is formed to have side sidewalls and a recessed portion defined in a central area. The heating element is positioned within the recessed portion of the base member, where the heating element is designed to exhibit an elevated temperature in response to being powered by an external rechargeable high-voltage battery power source. The socket configuration is configured to accept attachment of the external rechargeable high-voltage battery and is also connected to the heating element to provide the high-voltage electrical power for raising its temperature. The power switch is included to allow for a user to connect the external rechargeable high-voltage battery to the heating element (via the socket configuration). In use, the removable food container is disposed over the heating element, where in response to the activation of the power switch by the user, the high power voltage passing through the socket configuration is received by the heating element and used to generate thermal energy sufficient to raise the temperature of the food container.

Other and further embodiments of the present invention will become apparent during the course of the following discussion and by reference to the accompanying drawings.

### BRIEF DESCRIPTION OF THE DRAWINGS

Turning now to the drawings, where like numerals illustrate like parts in several views:

FIG. 1 is an exploded, isometric view of a first example embodiment of a portable food storage apparatus formed in accordance with the present invention, the illustration includes an example of a suitable external rechargeable high-voltage battery source that is not itself an element of the present invention;

FIG. 2 is an isometric view of base member portion of the food storage apparatus (and battery B) of FIG. 1, particularly illustrating the positioning of a mating collar on an outer shell of the base member;

FIG. 3 is an isometric view of the arrangement of FIG. 2, in combination with a positioned food container and associated cover;

FIG. 4 is a cut-away side view of the arrangement of FIG. 3, in this case with the associated cover shown in the closed position;

FIG. 5 shows an example block diagram of an electrical control circuit that may be connected between an included socket configuration and the heating element, the electrical control circuit used to provide the connection between an external power source (connected to the socket configuration) and the heating element;

FIG. 6 is an isometric, exploded view of an alternative example of a portable food storage apparatus, also formed in accordance with the teachings of the present invention;

FIG. 7 is an isometric view of an assembled portable food storage apparatus, having the components described above in association with FIG. 6

FIG. 8 is an another isometric view of the arrangement of FIG. 6, in this case shown in the closed position and oriented such that the socket configuration is clearly visible; and

FIG. 9 contains a more detailed illustration of a sidewall compartment portion of the example portable food storage apparatus of FIGS. 6, 7 and 8, in this view illustrating the relative positioning of the included electrical control circuit, socket configuration, and external power switch.

### DETAILED DESCRIPTION

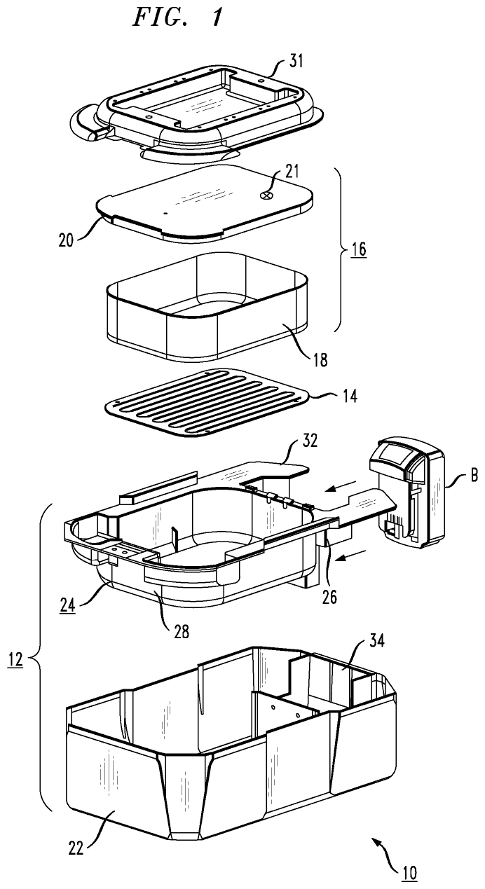

FIG. 1 is an exploded view of an exemplary form of the inventive food storage apparatus, referred to at times hereinafter as a “job site lunch box” for purposes of explanation. For the purposes of the present invention, the phrase “job site” is used to indicate the portable nature of the inventive food storage apparatus. In particular, FIG. 1 shows an example job site lunch box 10 comprising a base member 12, a heating element 14 and a food container 16. Food container 16 consists of a case 18 for holding the food and a lid 20 that fits snugly over case 18 and prevents the contents from spilling during transport. Lid 20 may also include a one-way steam gasket 21 to release any build-up of pressure in food container 16 during the heating process.

In this example embodiment, base member 12 comprises an outer shell 22 and a mating collar 24 that fits onto outer shell 22 upon assembly. A socket configuration 26 is shown in this example as forming an element of mating collar 24. As will be discussed below, socket configuration 26 is particularly configured to provide a proper electrical interface for allowing an external rechargeable high-voltage battery B to be attached to job site lunch box 10 and provide power to heating element 14, allowing food container 16 to be heated to a desired temperature. While shown in this view, battery B does not form part of the invention. Rather, in accordance with the principles of the present invention, battery B is contemplated as being any suitable type of conventional on-site battery (such as, for example, a rechargeable high-voltage power tool battery) that may be inserted into socket configuration 26. For the purposes of the present invention, the phrase “high voltage” is intended to define one or more of the voltage levels used to control typical power tools. These high voltage batteries are defined as operating at a voltage greater than ten voltage (e.g., 12V), with many conventional power tools use a rechargeable battery operating at 18V or 20V. Some examples of rechargeable high voltage batteries may operate at even greater voltages, such as a 40/60/80V battery, typically associated with high-end outdoor power equipment. Additionally, socket configuration 26 may take the form of any of several different well-known types of interchangeable interfaces or adapters, as required, to allow for compatibility of multiple, different types of rechargeable high-voltage battery sources with the operation of heating element 14. Typical rechargeable high voltage power tool batteries include, among others, Lithium-ion batteries, Nickel-Cadmium batteries, and Nickel-Metal Hydride batteries. Adapters are known that allow for these different types to be “switched out” as necessary, and here may form part of circuit configuration 26.

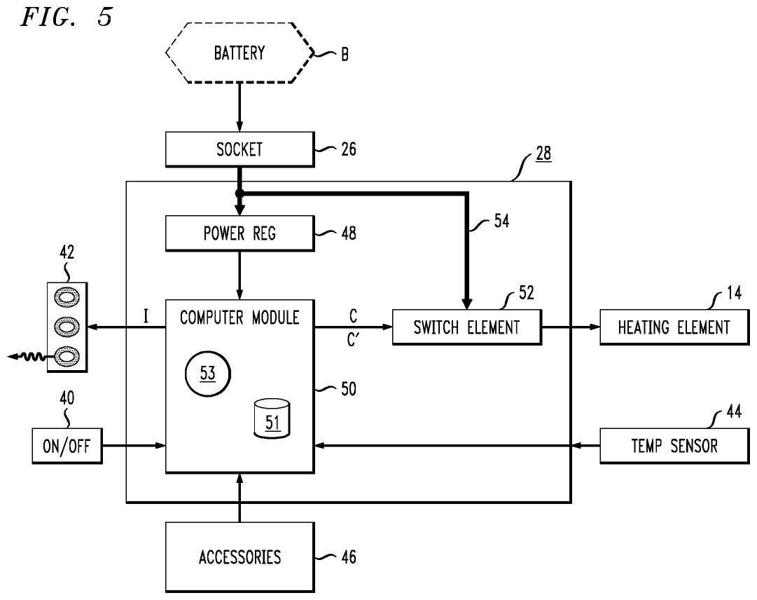

An electrical control circuit 28, described in detail below in association with FIG. 5, is included in job site lunch box 10 and provides the necessary electrical connection between the external battery B and heating element 14. In particular, electrical control circuit 28 is connected between socket configuration 26 and heating element 14 and used to provide a high power path therebetween (as mentioned above, an example power tool high-voltage battery typically operates at the 18/20V level). In particular, electrical control circuit 28 includes at least a switching mechanism that is responsive to an external “on/off” signal (provided by a user) and is used to create a direct, high power connection between the external rechargeable high-voltage battery B and heating element 14.

Also shown in the example embodiment of FIG. 1 is a cover 31 that is positioned over food container 16. While not a required component of the inventive apparatus, it is contemplated that in most situations it is useful to have a cover that “latches” onto the apparatus (e.g., at mating collar 24) to prevent food container 16 from falling out. Indeed, in embodiments where the inventive food storage apparatus is included in a “stack” of various on-site tool boxes, cover 31 may be configured to include latching mechanisms for interlocking with like mechanisms included with these other tool boxes (or any type of box, more generally). In another embodiment, the inventive food storage apparatus may be sized to fit within a conventional toolbox.

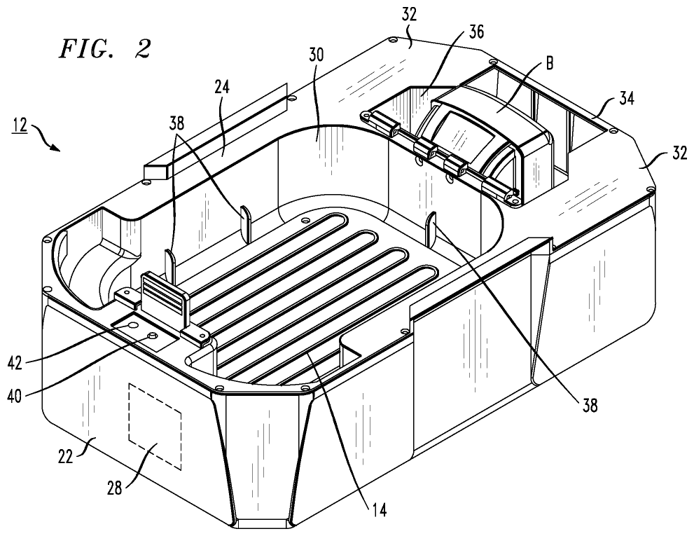

FIG. 2 is an isometric view of base member 12 of job site lunch box 10 as shown in FIG. 1 (as well as external rechargeable high-voltage battery B), particularly illustrating the positioning of mating collar 24 on outer shell 22. Also shown in this view is an example placement of heating element 14 within a recessed area 30 formed within base member 12. Recessed area 30 is also used to support food container 16, where food container 16 (as shown in FIG. 1) is positioned over heating element 14 In this example, mating collar 24 is formed to include a pair of extensions 32 that terminate at a sidewall 34 of outer shell 22. This combination of extensions 32 with sidewall 34 forms a sidewall compartment 36 that is used to support and protect external rechargeable high-voltage battery B upon attachment to job site lunch box 10. In particular, socket configuration 26 (not shown in this view) is also positioned within sidewall compartment 36 and located such that external rechargeable high-voltage battery B easily mates with the socket configuration as it is being lowered into place.

In the particular embodiment as shown in FIG. 2, mating collar 24 also includes a plurality of stand-offs 38 that help to center food container 16 over heating element 14, while also facilitating a snug fit of food container 16 within recessed area 30 as the food container is being lowered into place. The snug fit (which may also be referred to as a “motionless, but removable” fit) reduces the possibility of movement between these components when cover 31 is lowered in place, applying pressure to food container 16. It is to be understood that the use of stand-offs for providing a snug fit of food container 16 within recessed area 30 is only example; there may be a variety of different designs that serve the purpose of preventing movement/misalignment between heating element 14 and food container 16, yet allow for food container 16 to be easily removed as necessary. Any suitable alternative is considered as falling within the scope of the present invention.

Also shown in FIG. 2 is an on/off switch 40 that is activated by the user to connect external rechargeable high-voltage battery B to heating element 14 via electrical control circuit 28, as described in detail below in association with FIG. 5. An indicator element 42 is included as well, and may comprise one or more indicator LEDs (in one example) that provide visual clues to the user regarding the state of operation of the heating process. For example, indicator element 42 may include a first LED of a selected color (e.g., green) that indicates the “on/off” status of the heating process, and a second LED (e.g., red) that is energized when heating element 14 reaches a proper temperature for heating/cooking. Indicator element 42 may alternatively take the form of an audible (sound) element that is used to indicate operation status. Obviously, it is contemplated that a combination of visual and audio indicator elements may be used. Additional indicator elements may include a display (such as an LCD display) that illustrates status indicators such as “heating time,” “heating temperature,” and the like.

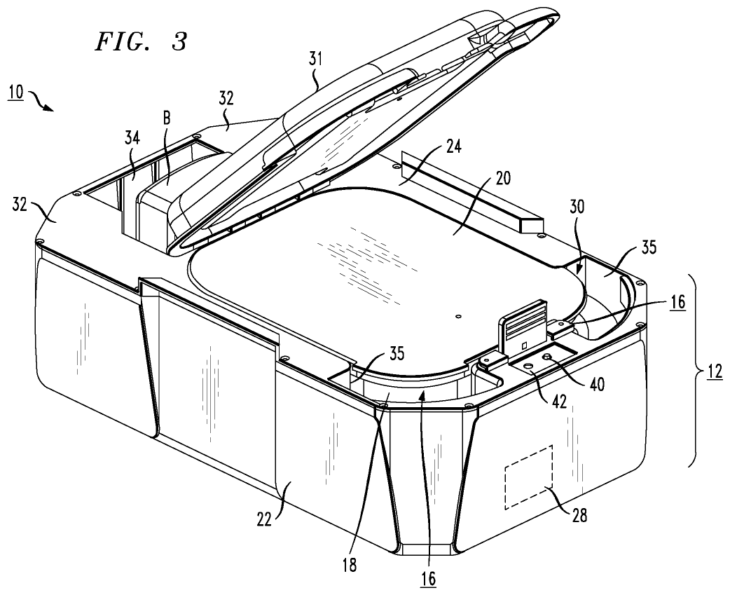

FIG. 3 is an isometric view of the arrangement of FIG. 2 in combination with a positioned food container 16 and associated cover 31. It is evident from this view that recessed area 30 of base member 12 is appropriately sized such that lid 20 of container 16 remains below the upper edge of mating collar 24. Preferably, recessed area 30 is configured to include access spaces 35, as shown, that aid a user in being able to remove food container 16 from its snug fit within the assembly (for example, when heating is completed, when arriving at home and needing to clean the container, etc.).

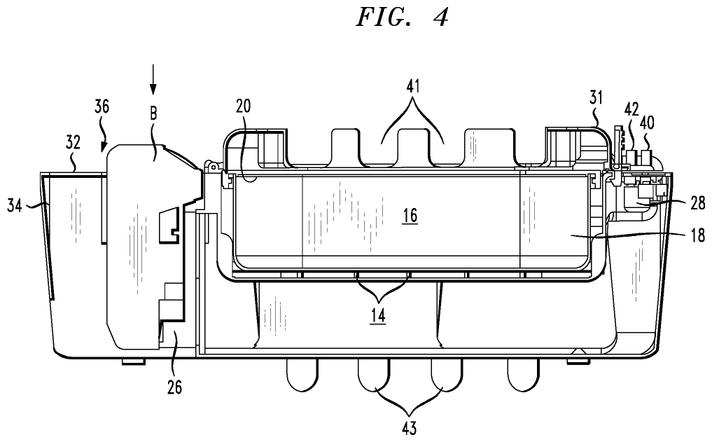

FIG. 4 is a cut-away side view of the arrangement of FIG. 3, with cover 31 shown here in the closed position. Particularly shown the view of FIG. 4 is one possible positioning of socket configuration 26 within sidewall compartment 36. It is contemplated that as an external rechargeable high-voltage battery B is lowered into position (indicated by the arrow in FIG. 4), its contact points will engage with socket configuration 26 in a manner that makes the necessary electrical connection. Also shown in FIG. 4 is a possible positioning of electrical control circuit 28, which is connected between an attached battery B (i.e., via socket configuration 26 as described above) and heating element 14. In operation, when an individual wants to begin the heating process, on/off switch 40 is activated, and an attached battery B is thereby connected to heating element 14 via electrical control circuit 28.

In certain embodiments of the present invention, it may be useful to configure the job site lunch box to include exterior features (at times referred to as clips) that allow for the lunch box to be stacked with, and attached to, other equipment casings. For example, tool boxes are known to include these clips to allow for one to be stacked over another for easier transportation. The cut-away side view of FIG. 4 illustrates one exemplary type of external feature. In particular, FIG. 4 shows a first plurality of mating features in the form of indentations 41 formed within a top surface of cover 31, and a second plurality of mating features in the form of raised elements 43 formed across a bottom surface of base member 12. Raised elements 43 are disposed in a pattern across the bottom of base member 12 that will align these elements with a set of underlying indentations 41 of a cover disposed below base member 12. The depth of indentations 41 and the height of raised elements 43 are coordinated so that they easily mate in a snug manner. In some configurations, this type of latching mechanism may take the form of a spring-loaded arrangement provides additional assurance that the stack will stay in place, until the user operates the latch, which releases the spring and easily separates the inventive job site lunch box from the rest of the stack.

FIG. 5 is a block diagram illustrating the functionality of an exemplary electrical control circuit 28, as used to provide the regulated heating of a food container positioned within inventive job site lunch box 10 (via an attached external rechargeable high-voltage battery B, which is not considered to be part of the inventive apparatus). It is to be understood that while in its most basic form the job site lunch box of the present invention only requires a user-controlled on/off switch to connect an attached external rechargeable high-voltage battery to the heating element, various other electrical-based features (e.g., indicators, accessories, and the like) may be included within apparatus 10 to provide additional functionality. Some of these features will be discussed below.

Continuing with reference to FIG. 5, exemplary electrical control circuit 28 is shown as connected to various components of the inventive job site lunch box 10, including at least socket configuration 26, on/off switch 40, and heating element 14. For illustrative purposes, an external rechargeable high-voltage battery B (not considered to be a component of the inventive apparatus) is also shown in FIG. 5, indicating its attachment to socket configuration 26. In most embodiments, electrical control circuit 28 is further used to power one or more devices included within job site lunch box 10 formed in accordance with the present invention. For example, electrical control circuit 28 may also be used to control the energizing of various ones of indicator elements 42 during the heating process. As mentioned above, indicator elements 42 may include one or more of status LEDs, sound alarms, an LCD display, or the like.

A temperature sensor 44 is also shown in the block diagram of FIG. 5, where this device may be used in this embodiment to monitor the ambient temperature of heating element 14 so that proper working conditions are maintained. In implementation, care should be taken to position temperature sensor 44 as close to heating element 14 as possible. Various other external electronic devices, referred to generally as accessories 46, may also be included certain embodiments of the present invention. These accessories also require power from electrical control circuit 28 and may include, but are not limited to, a circulating fan (to ensure uniform heat distribution across the bottom of the food container), a user-activated timer (in the form of an “external” device as opposed to a timing circuit contained within electrical control circuit 28) to set a heating interval, a user-activated temperature controller for setting desired conditions for heating the food, an LCD screen for displaying information such as temperature, time, etc., and other useful accessories not specifically enumerated.

Electrical control circuit 28 itself is depicted in the example embodiment of FIG. 5 as including a power regulator 48, a computer module 50, and a switch element 52. As discussed above, the electrical power entering control circuit 28 via socket configuration 26 is presumed to be a relatively high power as generated by a conventional external rechargeable high-voltage battery (e.g., typical values of at least 10V, usually 18V/20V, or even voltage levels of 40, 60, or 80 volts). Advantageously, that relatively high power is useful in efficiently raising the temperature of heating element 14 so as to heat the food within container 16. Therefore, electrical circuit 28 is shown as including a direct high power connection 54 between rechargeable high-voltage battery B and heating element 14, as controlled by the action of switch element 52, discussed below. The thicker lines in FIG. 5 (such as connection 54) are depicted to define a “high power” connection, with the remaining lines showing typical low power circuit connections.

The remaining electrical elements as contained within electrical control circuit 28 cannot typically operate at the high power output generated by an external rechargeable high-voltage battery B. Thus, power regulator 48 is used to reduce the incoming voltage level (for example, 20V) to that suitable for the operation of electrical circuitry (for example, 3-5 V). This reduced level of operating voltage is applied as a power input to computer module 50 and used to control its operation. In this example, computer module 50 is shown as receiving an input from power switch 40. In response to this input, computer module 50 provides an “on” control signal input C to switch element 52, connecting the high power line 54 output from rechargeable high-voltage battery B to heating element 14. Upon the activation of power switch 40, computer module 50 may also send an output indicator signal I to a selected one of indicator element(s) 42, showing that the unit is now energized.

Computer module 50 is also shown as receiving an input from temperature sensor 44, where this input (typically a current) can be correlated with a specific temperature of heating element 14. Computer module 50 may use this information for a variety of functions. For example, a specific indicator element 42 (e.g., an LED) may be turned on when computer module 50 determines that the desired heating temperature has been reached (based on the input from temperature sensor 44). Further, computer module 50 may thereafter send an updated control signal C′ to switch element 52, which is used to disconnect (temporarily, perhaps) the external rechargeable high-voltage battery from heating element 14 and thus prevent a further, unwanted increase in temperature.

Computer module 50 may also include a memory element 51 that stores, for example, tables of operational information, such as a correlation between incoming current from temperature sensor 44 and temperature of heating element 14. Memory element 51 may also store operational information such as a set of standard temperature cycling times that may be used to control the operation of switch element 52 (thereby enabling automated and enhanced operational functionality). A timing element 53 may also be included in computer module 50 and used to control the operation of switch element 52 as a function of elapsed time. Timing element 53 may be configured to use an automatic, pre-defined timing interval or accept as an input a user-selected timing interval; indeed, it is contemplated that embodiments of the present invention may utilize both pre-programmed timing and user-defined timing.

Other elements that may be included within (or controlled by) computer module 50 may take the form of components that provide protection for an attached rechargeable high-voltage battery, such as overcurrent protection, thermal shutdown, and output voltage monitoring. Additional elements may include a means for authenticating the type of battery being attached, so as to adjust operation to a proper voltage level (e.g., 18V vs 10V), as well as prevent incompatible power sources from being used.

An accessories component 46 is also shown in the diagram of FIG. 5, and is used to represent various other electronic devices that may be included within the inventive job site lunch box and powered by included electrical control circuit 28. For example, accessory 46 may take the form of a circulating fan that is disposed in proximity to heating element 14 and used to even out the temperature distribution along the bottom surface of food container 16. In another case, accessory 46 may comprise an external time or temperature controller that is operated by the user. These accessories, as well as others, may be used in any desired combination to suit the purposes of a particular configuration of the job site lunch box of the present invention.

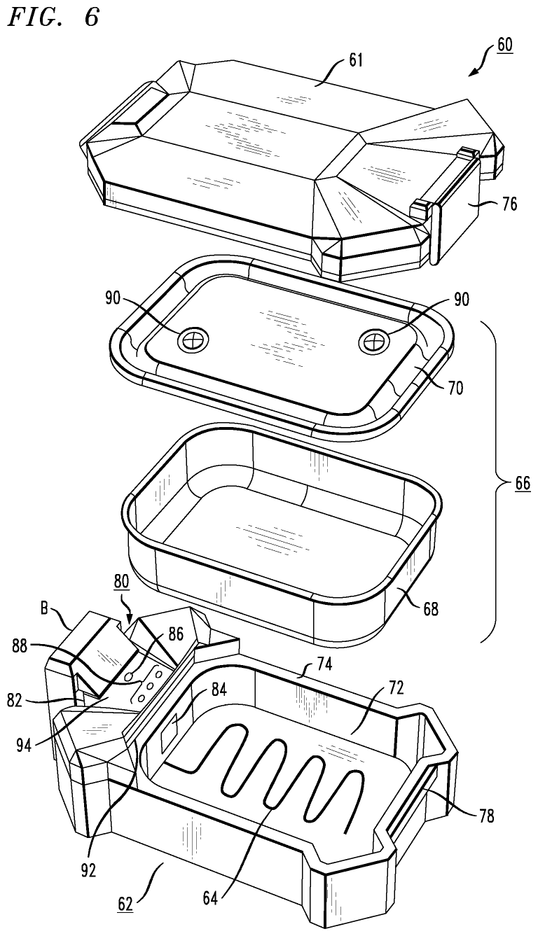

FIG. 6 is an exploded view of another embodiment of the inventive job site lunch box, also formed in accordance with the inventive principles as described above. In particular, FIG. 6 shows an example job site lunch box 60 comprising a base member 62, a heating element 64, and a food container 66. Similar to food container 16 described above, food container 66 consists of a case 68 for holding the food and a lid 70 that fits snugly over case 68 and prevents the contents from spilling during transport. In this embodiment, base member 62 is formed to include a recessed compartment 72 having dimensions suitable for supporting food container 66 when positioned therein. The “suitable” dimensions include forming the recess to be deep enough such that lid 70 of food container 66 does not protrude above a side wall 74 of base member 62, as well as the “motionless, releasable” snug fit of food container 66 within recessed compartment 72, as discussed in association with the previous embodiment. A cover 61 for lunch box 60 is also shown in FIG. 6. While not required for the heating functionality of the present invention, such a cover may be beneficial in environments where extraneous debris and the like have the possibility of falling into recessed compartment 72. Additionally, the inclusion of a cover helps to maintain the internal temperature of the lunch box when at least the base member is formed of an insulative material (and/or double-walled structure), as mentioned below.

In this example, cover 61 is shown as including a latching member 76 that is positioned to mate with an extended ridge 78 formed on base member 62 as cover 61 is closed over base member 62. The use of a latching configuration is exemplary only, and may be a preferred embodiment when a reliable closure of top cover 61 over base member 62 and the included food container 66 is necessary. As with the embodiment described above, cover 61 (as well as other components of the assembly) may be formed to include additional latching mechanisms that mate with like elements on a separate tool box (not shown) to create a locked stack.

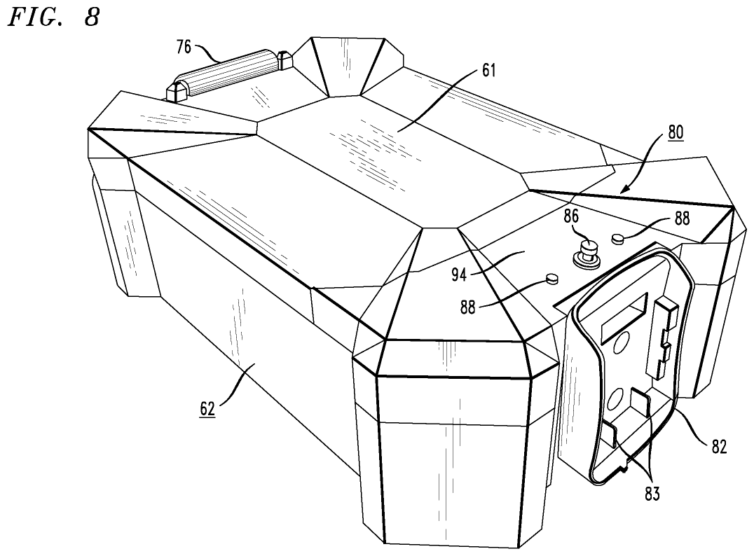

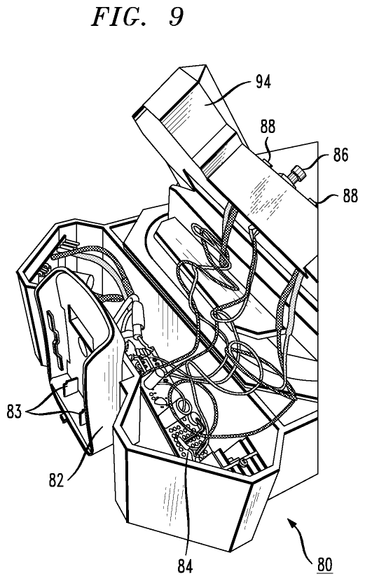

Also shown in FIG. 6 is a conventional portable, rechargeable high-voltage battery B (e.g., a power tool battery or another rechargeable battery source operating at a voltage in excess of 10V), that is used as a power source to heat the food within container 66. In this exemplary embodiment, rechargeable high-voltage battery B is shown as attached to a sidewall compartment 80 formed along an exterior surface of base member 62. In particular, sidewall compartment 80 is formed to include an appropriate socket configuration 82 (best shown in FIGS. 8 and 9) for connecting rechargeable high-voltage battery B to an included electrical control circuit 84, where circuit 84 may also be located in compartment 80. In this example, a top cover 94 of compartment 80 is shown as supporting a power switch 86 (for activating the heating process), and one or more indicator elements 88 that may denote that heating is in progress, heating is completed, and perhaps internal temperature. Other indicators and/or accessories as discussed above may be included in this embodiment as well and are considered to fall within the scope of the present invention. Also shown in FIG. 6 is a pair of steam gaskets 90, formed through lid 70 and used to ensure proper venting during the heating process.

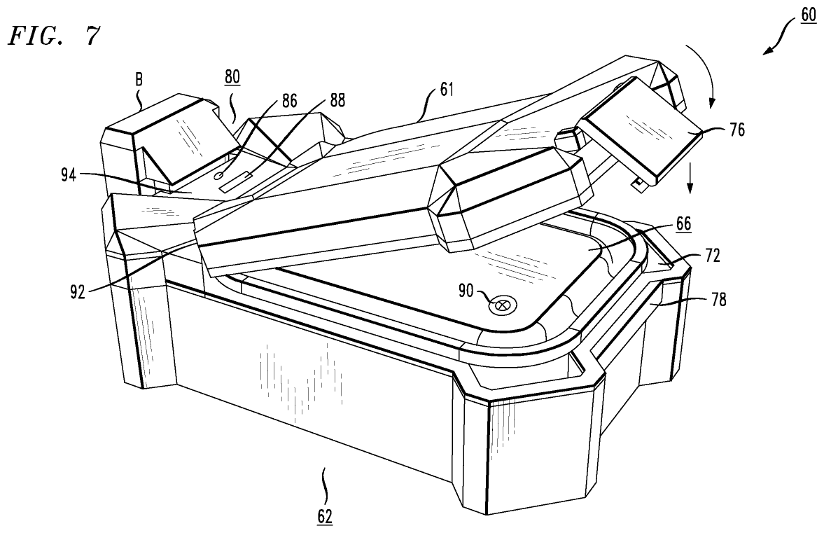

FIG. 7 is an isometric view of an assembled job site lunch box 60, having the components described above in association with FIG. 6. Evident here is the placement of food container 66 within recessed compartment 72 of base member 62. Cover 61 is shown as attaching to a support element 92 of base member 62 (support element 92 shown best in FIG. 6), where a hinged attachment may be used. The use of a hinged attachment in this particular embodiment allows for cover 61 to be lowered in position over recessed compartment 72 (and included food container 66), with latching mechanism 76 moving downward (rotating) to engage with extended ridge 78 of base member 62.

FIG. 8 is another isometric view of job site lunch box 60. Here, lunch box 60 is shown in its closed position, with lid 61 positioned over base member 62. As mentioned above, a latching mechanism 76 (best shown in FIGS. 6 and 7) may be used to secure lid 61 in place. Best illustrated in this view is socket configuration 82, which is considered to be one example of the type of interface that may be used to secure an external rechargeable high-voltage battery to lunch box 60. Socket configuration 82 is shown as including a pair of electrical contacts 83, which will provide the power coupling between the external rechargeable high-voltage battery and an included electrical control circuit 84 (as shown in FIG. 9, discussed below).

The illustration of FIG. 8 also shows sidewall compartment 80 in its closed position, with an example positioning of power switch 86 and indicator elements 88 shown on top cover 94. Here, indicator elements 88 are shown as two separate LEDs, presumably of different color, used to indicate the status of a heating operation.

FIG. 9 is a more detailed illustration of sidewall compartment 80 of job site lunch box 60, as discussed above in association with FIGS. 6, 7 and 8. In this example, top cover 94 is lifted to show an example placement of electrical control circuit 84 within sidewall compartment 80. Socket configuration 82 is again shown in this view, as well as electrical contacts 83. In particular, socket configuration 82 is shown as positioned on the exterior surface of sidewall compartment 80, where socket configuration 82 is used for accepting attachment of an external rechargeable high-voltage battery B (as shown in FIGS. 6 and 7) and providing power to the arrangement, allowing for heating of food stored within container 16 to take place. The wires connecting socket configuration 82 to electrical control circuit 84 are shown in this view, as well as the wires connecting power switch 86 and indicator elements 88 to electrical control circuit 84. The details of electrical control circuit 84 may be similar to those discussed above in association with electrical control circuit 28 of FIG. 5, and will not be repeated here.

In general, heating element 14, 64 may comprise any one of a number of suitable alternatives. For example, the heating element may comprise a patterned layer of a metal that exhibits a high level of thermal resistivity upon the application of a current. The heating element may also be a type of polyimide foil or carbon fiber (for example) that is also known to exhibit an increase in temperature as a current passes through it (resistive heating). Alternatively, it is contemplated that required heating of an included food container (may be provided via an induction heating coil, or a conductive heating plate disposed within the bottom portion of the base member of the inventive job site lunch box. Infrared radiant heating may also be used. Various types of heat distribution channels may also be included in the base element and/or a circulating fan may be included as an accessor to the electrical control circuit to improve the uniformity of the heating process.

As mentioned above, while on-site power tool batteries (Li ion batteries, generally) are considered as a preferred power source, other alternatives are contemplated and considered as falling within the scope of the present invention. For example, a wireless power receiver coil may be used in combination with an available compatible source. Docking chargers as found on computers and in some vehicles may also be used.

In preferred embodiments, both the base member and cover of the job site lunch box are formed of a double-walled insulated design, as preferred for food storage. In keeping with job site applications for the inventive food storage apparatus, the material used for these components is preferably a drop-resistant rubber or plastic composite material. Specific materials such as a graphene-reinforced polymer (known to be strong, lightweight and durable) may also be used for these outer components of the job site lunch box. Other material choices may be based on features such as high-temperature resistance, water-resistant and/or waterproof, depending on a specific environment where the lunch box may be used. The use of closed-cell insulation, a double-walled configuration, or vacuum-sealed walls may be used in the formation of at least the base member to maintain the food's temperature for extended time periods.

A vibration-dampened mount for the battery socket configuration connection may be advantageous for protecting both the battery and internal electronics during transport. Materials and configurations of the base member, food container, and lid may be particularly selected to ensure proper operation in harsh climates, including exposure to dust, moisture, vibration, and temperature extremes. In some embodiments, fold-out legs may be added to the underside of the base member to form a table-like structure. Accessories beyond the circulating fan mentioned above may include a Bluetooth connection for heating to be controlled remotely via a phone or other smart device, where the utilization of this type of connection allows for additional features such as control of heating temperature, heating time, the provision of alarms and announcements during heating, and the like.

The embodiments of the present invention as described above are to be considered as exemplary only and are not intended to limit the scope of the invention as defined by the appended claims. Any equivalent embodiments are intended to be within the scope of this disclosure and, indeed various modifications of the described embodiments, such as alternative useful combinations of the described elements, may become apparent to those skilled in the art. Such modifications and embodiments are also intended to fall within the scope of the claims appended hereto.

What is claimed is:

1. A portable food storage apparatus comprising:
a base member having sidewalls and a recessed portion defined in a central area;
a heating element disposed upon the recessed portion of the base member, the heating element designed to exhibit an elevated temperature in response to an electrical power applied thereto;
a socket configuration configured to accept attachment of an external rechargeable high-voltage battery, the socket configuration connected to the heating element to provide the high-voltage electrical power for raising its temperature;
a power switch for connecting the socket configuration to the heating element as controlled by a user; and
a removable food container disposed over the heating element, where in response to the activation of the power switch by the user, the high power voltage passing through the socket configuration is received by the heating element and used to generate thermal energy sufficient to raise the temperature of the removable food container.

2. The portable food storage apparatus as defined in claim 1, further comprising
an electrical control circuit connected between the power switch and the heating element, wherein the socket configuration is also connected to the electrical control circuit and used to direct electrical power from the external, rechargeable power supply to the electrical control circuit.

3. The portable food storage apparatus as defined in claim 2, wherein the apparatus further comprises at least one indicator element activated by the electrical control circuit in response to power switch activation.

4. The portable food storage apparatus as defined in claim 3 wherein the at least one indicator element includes at least an LED that is energized when the power switch is activated.

5. The portable food storage apparatus as defined in claim 4 wherein the at least one indicator element comprises a plurality of LEDs, each LED of a different color and separately energized to denote a status of a heating operation.

6. The portable food storage apparatus as defined in claim 2, wherein the apparatus further comprises one or more indicator elements selected from the group consisting of LEDs, LCD devices, and audio devices, the one or more indicator elements activated by the electrical control circuit in response to the status of a heating operation.

7. The portable food storage apparatus as defined in claim 2, wherein the apparatus further comprises a temperature sensor disposed in proximity to the heating element, the temperature sensor generating an electrical output signal relative to temperature and directing the electrical output signal to the electrical control circuit.

8. The portable food storage apparatus as defined in claim 2, wherein the electrical control circuit includes a power regulator coupled to an output of the socket configuration, the power regulator configured to reduce the high-voltage output power from the external rechargeable high-voltage battery to a level suitable for electrical circuit functionality.

9. The portable food storage apparatus as defined in claim 8, wherein the electrical control circuit further comprises
a computer control module, responsive to an input signal from the power switch and utilizing the input signal to generate a control signal for the heating element; and
a switch element connected between the computer control module and the heating element, the switch element also responsive to the high-voltage output power from the socket configuration, where in response to receiving the control signal from the computer control module, the switch element connects the high-voltage power passing through the socket configuration from the external rechargeable high-voltage battery to the heating element.

10. The portable food storage apparatus as defined in claim 9, wherein the computer control module includes a memory element for storing at least information associating an applied current input to the heating element with a temperature generated by the heating element.

11. The portable food storage apparatus as defined in claim 10, wherein the apparatus further comprises a temperature sensor and the memory element further includes information correlating an input current received from the temperature sensor with an ambient temperature of the heating element.

12. The portable food storage apparatus as defined in claim 10, wherein the memory element of the computer control module further stores one or more temperature cycling heating profiles to be used by the switching element to control the connection between the socket configuration and the heating element.

13. The portable food storage apparatus as defined in claim 9, wherein the computer control module includes a timing circuit for disconnecting the socket configuration from the heating element after a defined time interval has elapsed.

14. The portable food storage apparatus as defined in claim 2, the apparatus further comprising at least one electronic device accessory powered by the electrical control circuit.

15. The portable food storage apparatus as defined in claim 14 wherein the at least one electronic device includes a circulating fan positioned proximate to the removable food container and used to improve temperature uniformity across a surface of the removable food container during the heating process.

16. The portable food storage apparatus as defined in claim 1 wherein the base member is formed to include an interior sidewall compartment into which the external, rechargeable power supply may be inserted, the socket configuration disposed in relation to the interior sidewall compartment such that electrical contact is formed and maintained between the external rechargeable high-voltage battery and the socket configuration during insertion of the external rechargeable high-voltage battery.

17. The food storage apparatus as defined in claim 1, wherein the removable food container comprises a case and a separate lid, the separate lid fitting in a snug, removable manner over the case.

18. The portable food storage apparatus as defined in claim 17 wherein the separate lid of the food contained includes a one-way steam vent to prevent a build-up of internal pressure during the heating process.

19. The portable food storage apparatus as defined in claim 1, further comprising
a cover positioned over the base member and including at least one latching mechanism for ensuring that the cover remains in place as the food storage apparatus moves from one location to another.

20. The portable food storage apparatus as defined in claim 19, wherein the cover is formed of an insulating material.

21. The portable food storage apparatus as defined in claim 18, wherein the portable food storage apparatus further comprises a set of stacking clips for enabling the portable food storage apparatus to be stacked with other equipment boxes, the set of stacking clips including
a first plurality of mating features formed on a top side of the cover; and
a second plurality of mating features formed on a bottom side of the base member, wherein the first and second pluralities are configured to align and engage with one another upon stacking of the portable food storage apparatus with other equipment boxes.

22. The portable food storage apparatus as defined in claim 21, wherein
the first plurality of mating features comprises a plurality of indentations disposed in a defined pattern across the cover top surface, each indentation having a defined geometry and a defined depth; and
the second plurality of mating features comprises a plurality of raised elements disposed in the defined pattern across the bottom surface of the base member so as to align with the positions of the first plurality of mating features of another box, each raised element having a geometry and height acceptable for mating with an associated indentation.

23. The portable food storage apparatus as defined in claim 21 wherein the set of stacking clips comprise spring-loaded elements controlled by a user to separate the portable food storage apparatus from the stack.

24. The portable food storage apparatus as defined in claim 1 wherein the base member is formed as an insulated structure.

25. The portable food storage apparatus as defined in claim 24 wherein the base member is formed of a closed-cell material to provide insulation.

26. The portable food storage apparatus as defined in claim 24 wherein the base member comprises a double-walled insulative structure.
